(19) United States
(12) Patent Application Publication
(10) Pub. No.: US 2022/0281679 A1
(43) Pub. Date: Sep. 8, 2022

(54) DEBRIS COLLECTION AND DISPOSAL SYSTEM

(71) Applicant: Ken Jagr, Purdys, NY (US)

(72) Inventor: Ken Jagr, Purdys, NY (US)

(21) Appl. No.: 17/190,585

(22) Filed: Mar. 3, 2021

(51) Int. Cl. B65F 1/08; A01G 20/43

(52) U.S. Cl. CPC B65F 1/08; A01G 20/43; B65F 2240/138

(57) ABSTRACT

A debris removal system includes a plurality of straps and netting interconnected to one another. A debris removal system may also include a reinforcement coupled to a portion of the plurality of straps that raises at least a portion of the netting upward from a support surface to form a netted canopy.

### FIELD OF THE INVENTION

Disclosed are embodiments of the invention that relate to, among other things, collection, transportation, and/or disposal of waste material, in particular, yard, street, and surface waste such as leaves, litter, and storm residuals.

### BACKGROUND

Collection of waste found in yards, streets, and other populated areas tends to be very labor intensive and imprecise, often requiring the use of various tools and collection bins, bags, and the like.

Typically, collecting the aforementioned wastes involve making compromises in terms of how much waste to collect and how often the waste can be collected, transported, and disposed. Present systems and devices provide for advantageous waste collection but unfavorable means of transportation and disposal.

### SUMMARY OF THE INVENTION

An exemplary device and system may ease collecting, transporting and disposing of large quantities of land waste, e.g., leaves, grass and yard debris, by a person/persons and motorized vehicle.

An exemplary device may comprise a web framing that allows for ease of transport by person/persons, motorized vehicle, or motorized device, such as, for example, a wench.

An exemplary device may comprise one or more hand loops located about an upper center ridge, the hand loop enabling the disposal of the yard material by hand if desired.

An exemplary device and system may further comprise one or more stake-downs with one or more of the following functions: holding down a front arch of an exemplary web framing to enable collecting the land debris, e.g., leaves, and holding down a rear of an exemplary system to dispose of the land debris, e.g., leaves.

Another aspect of the exemplary device and system is a tow loop which allows for coupling between the system and a motorized vehicle or device, e.g., cart or wench, or to enable pulling by hand by one or two people.

In another exemplary aspect of the exemplary device and system, the construction may be a complete one-piece collection comprised of collapsible parts, such as poles, and folding connections, all of which increase handling and storage of the system.

### BRIEF DESCRIPTION OF THE DRAWINGS

FIGS. 1A and 6A each illustrates an exemplary inventive waste disposal system without exoskeleton supports.

FIGS. 1B, 2A, 2B, 2C, 3A, and 3B illustrate isometric, front, rear, profile, topographic, and bottom views of an exemplary waste disposal system with exoskeleton.

FIGS. 4A-B illustrate sections of exemplary connector 21 embodiments.

FIGS. 5A-G illustrate various views of an exemplary stake to be used to hold down an exemplary waste disposal system.

FIG. 6B illustrates an isometric view of the exemplary waste disposal system of FIG. 6A with support pieces.

In the drawings like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION

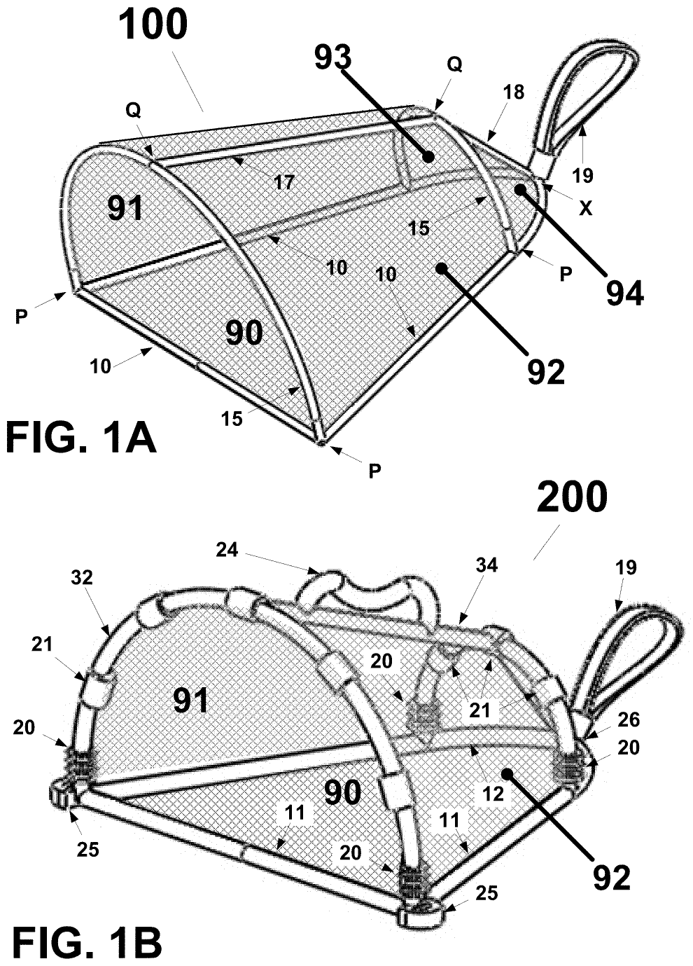

With respect to FIG. 1A, a webbed strap frame 100 comprises several base frames 10 that may form the structural core for the system 200 (as will be shown in FIG. 1B). A frame loop 15 connects to base frame 10 at junction points P. In an exemplary embodiment, a netting 90 interconnects all the various base frames 10 to form a bottom base. In another exemplary embodiment, netting 91 and netting 92 interconnect loop 15 to base frame 10 between junction points P on the webbed strap frame 100. Spine strap 17 may interconnect a plurality of loops 15 used in webbed strap frame 100 at junction points Q (and while FIG. 1A may show only two loops 15, any number may be used in accordance with field needs of the systems disclosed). Netting 91 and 92 may also interconnect loop 15, base frame 10, and spine strap 17 to form lateral flanks. Similar to spine strap 17, rear strap 18 may interconnect at least one loop 15 to terminus X, although rear strap 18 may connect multiple loops 15 to the extent the system takes on configurations that use multiple termini X (e.g., a double or triple lobed webbed strap frame 100. Netting 93 and 94 may interconnect at least one loop 15, rear strap 18, and base strap 10 to form rear encasement. In an exemplary embodiment points Q may be the peaks of the loops 15, but may be located anywhere along loop 15 where maximum pulling stresses may be encountered. Tow loop 19 enables pulling and adjustment of the entire webbed strap system 100, for example, if a user wishes to drag away webbed strap system 100, they may do so via tow loop 19 using trucks, carts, winches, and other pulling mechanisms known to those skilled in the art.

Webbed strap system 100 may be made out of numerous materials capable of withstanding collection of debris and ease of transport, such as, for example, rope and strap materials found in camping, rock climbing, hiking, or other rigorous activities. An exemplary strap material making up frames 10, loops 15, and straps 17, 18, and 19 may be of any cross-section and have any type of coating to permit flexibility of use with other system components disclosed. In an exemplary embodiment, the interconnection of 10, 15, 17, and 18 may be provided for more durability, structural integrity, and equality in the distribution of stresses caused by pulling across the entire system 100. Further, the system 100 may have very large capacities compared to prior art debris handling systems, exceeding 150-gallons.

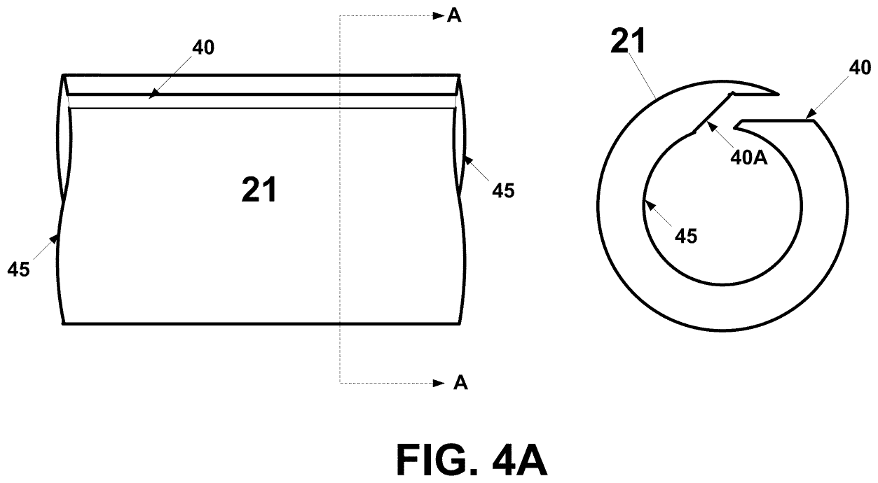

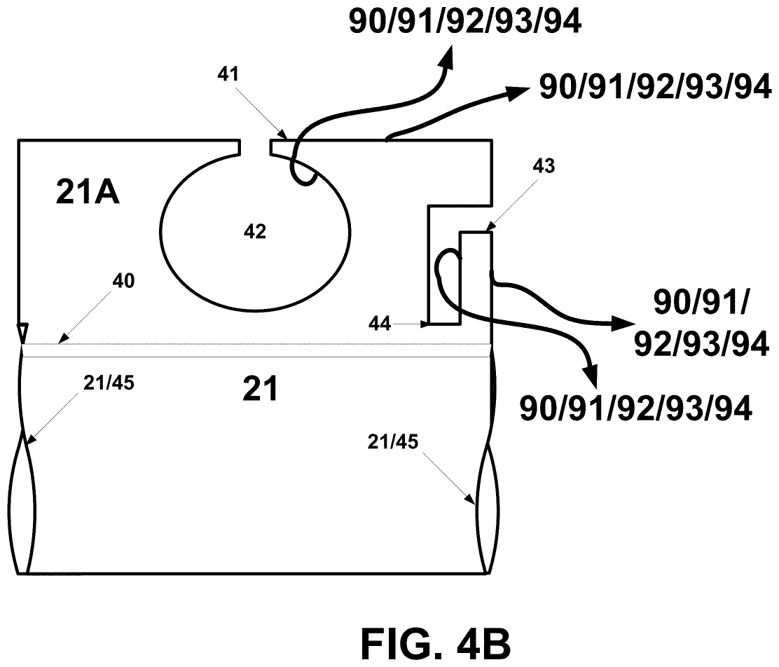

With reference to FIG. 1B, elements are seen added to the webbed strap system 100 to form a support frame 200 which may have structure for securing the webbed strap system 100 to the ground and maintain its structure during debris collection. A plurality of pole sleeves 21 interconnected by arched pipes or poles 32 may be used to slidingly receive the loops 15 of webbed strap system 100 via slots 40 (see FIG. 4A). Pole sleeves 21 may mate with poles 32 in various forms, including threaded connections, friction fit, snap fit, snap and lock, via use of fasteners, or be welded, friction welded, or co-molded. Moreover, in an exemplar embodiment poles sleeves 21 and their respective arched pipes or poles 32 may be an integrated structure with uniform perimeter/circumference. While illustrated as circular in cross-section, any other polygonal cross-section may be utilized for one or more of pole sleeves 21, pipes/poles 32, and other components of support frame 200.

An exemplary support frame 200 may also have a plurality of pole pockets 20 and base pipes 11/12 that may slidingly receive the straps 10 of webbed strap system 100 via slots 40 (see FIG. 4A). In an exemplary embodiment, pole pockets 20 and/or base pipes 11/12 receive points P of the webbed strap system 100. In a preferred embodiment, the base pipes 11/12 and the arched pipes/poles 32 may be of substantially similar thickness, cross section, and material. Alternatively, base pipes 11 and 12 may be made of heavier material than the remainder of support frame 200 components and/or have a different cross section to effect increase stability, e.g., a trapezoidal cross-section as opposed to a circular cross section. Pole pockets 20 may mate with poles 32 and base pipes 11/12 in various forms, including threaded connections, friction fit, snap fit, snap and lock, via use of fasteners, or be welded, friction welded, or co-molded. Moreover, in an exemplary embodiment, pole sockets 20 and their respective pipes 11/12 may be an integrated structure with uniform perimeter/circumference. While illustrated as circular in cross-section, any other polygonal cross-section may be utilized for one or more of pole sockets 20, base pipes 11/12, and other components of support frame 200.

As disclosed, with straps 10 received within the corresponding slots 40 of base pipes 11/12, netting 90 may likewise be held in place by base pipes 11 and 12 to form a foundation for the support frame 200. Where points P and X of the webbed system 100 are located may be found grommets 25 connected or integral with the pipes 11/12 as the case may be. The function of the grommets 25 may be to further enhance the stability of the frame 200 and/or be a point for further anchoring to the working surface, e.g., dirt, gravel, sand, concrete.

Pole sockets 20 may be similar to pole sleeves 21, with the exception that they have at least one face for coupling a junction of pipes 11, 12, and 32. This connection may be by way of snap-fit or by a geometry that accommodates the meeting of the various cross-sections of pipes 11, 12, and 32. For example, where pipes 11, 12, and 32 are all the same circumference and thickness, the joining face of pole socket 20 may be similar to a 3 Way L Fittings, 1 inch Diameter, Furniture Grade PVC made and sold by Circo Innovations. Moreover, any of the pipes 11, 12, 32, and any others disclosed herein may be constructed from PVC piping or designed like PVC piping known to those skilled in the art. As illustrated, pipe 12 may also differ from the configuration of pipe 11, e.g., be bent or triangular, where as pipe 11 may be straight.

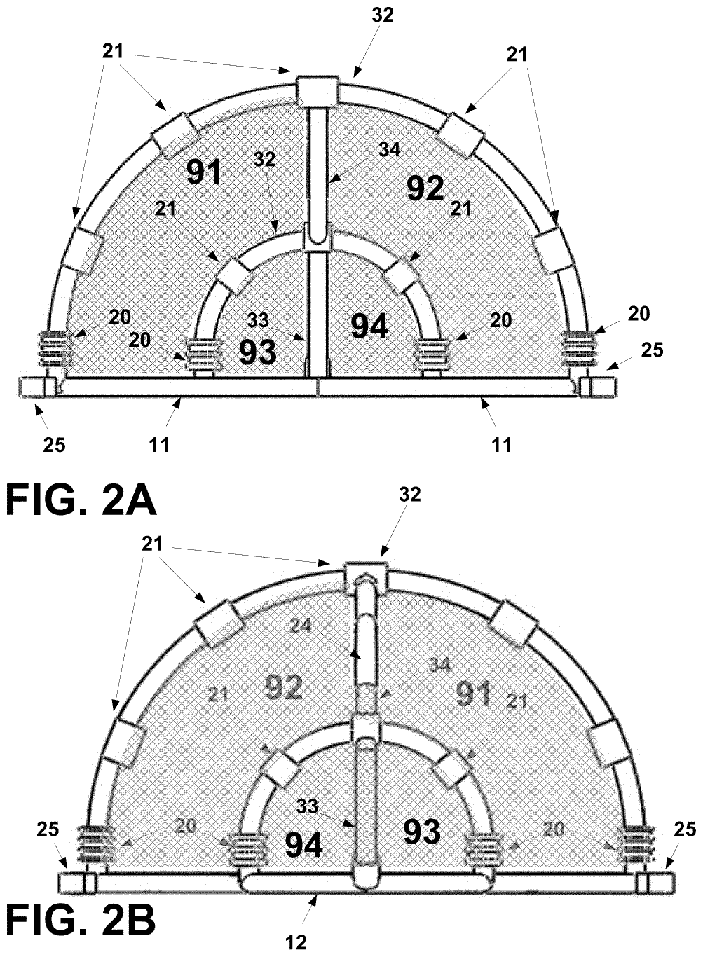

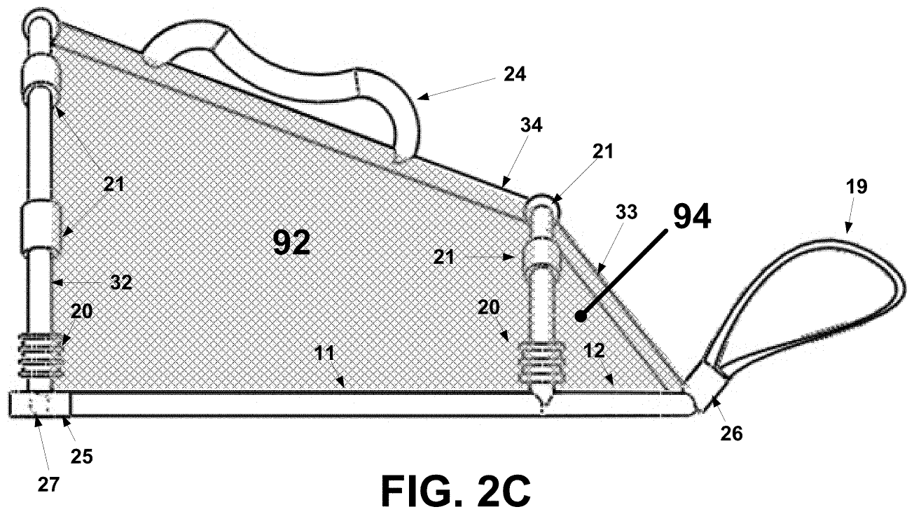

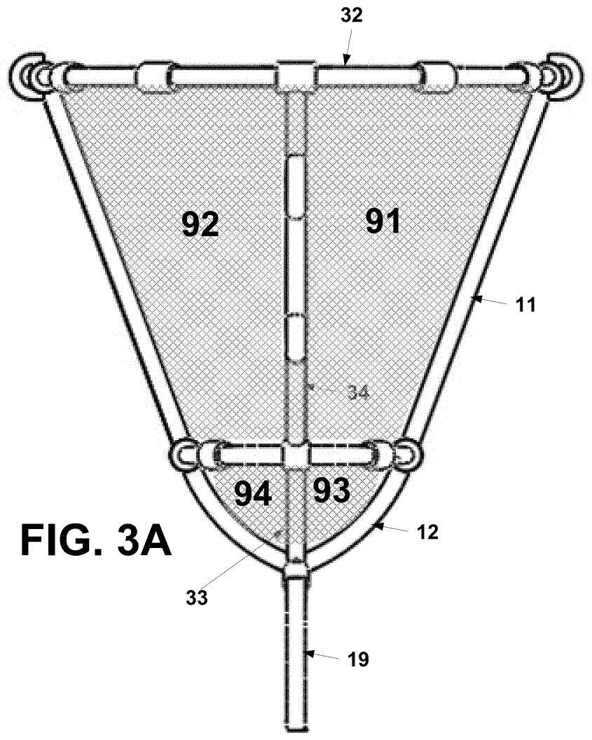

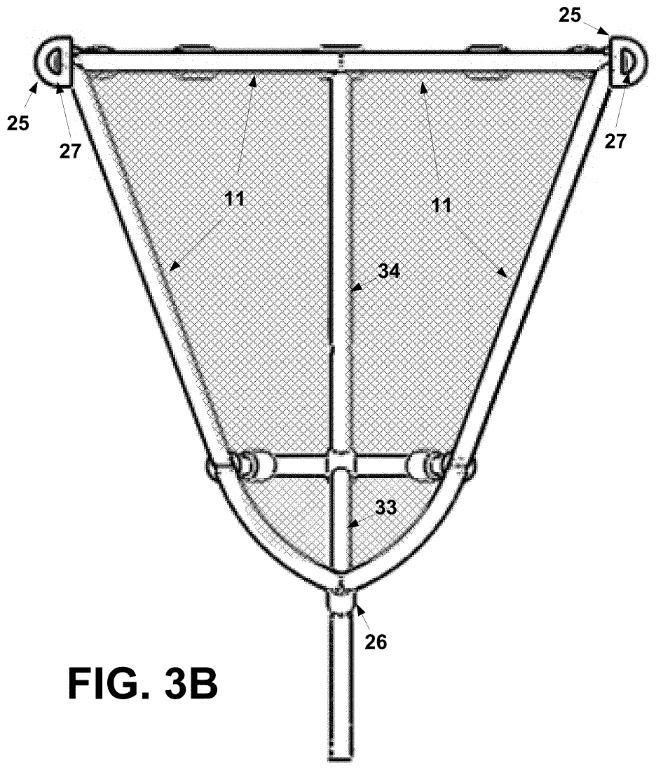

As arranged, pole sockets 20 join arched pipes 32 and their respective interconnected pole sleeves 21 so that straps 15 may be received in slots 40. In this way, netting 91 and 92 may be held by the arched construct made by sockets 20, arched pipes 32, and pole sleeves 21. As illustrated in FIGS. 1B, 2A, 2B, and 2C, and 3A and 3B, the canopy formed of netting 91, 92, and the arched components 32 of support frame 200 and base pipes 11 of the support frame 200 may be further supported by a spine pipe 34. With reference again to FIGS. 1B, 2A, 2B, and 2C, and 3A and 3B, the canopy formed of netting 93, 94, and the arched components 32 of support frame 200 and base pipes 12 of the support frame 200 may be further supported by a back pipe 33. As further illustrated by FIGS. 1B, 2A, 2B, and 2C, and 3A and 3B, each of back pipe 33 and base pipes 12 may join a tail sleeve 26 through which tow loop 19 may be drawn through. In an exemplary embodiment, tail sleeve 26 connects base pipes 12 and back pipe 33 in similar manner to pole sockets 20 and may be similarly configured and dimensioned. Alternatively, tail sleeve 26 may be integral with one or more of base pipes 12, back pipe 33, and/or combinations of the same. In a further exemplary embodiment, a handle 24 may be integrally molded with spine pipe 34 for ease of carrying the frame 200. Alternatively, handle 24 may be attached through the canopy of netting 91/92 to spine pipe 34 by mechanical fastening (e.g., screws, bolts, snap-fit arrangements).

FIGS. 1B, 2A, 2B, and 2C, and 3A and 3B illustratively provide for the fully assembled debris collection and disposal system as exemplified by a web frame 100 that is further rigidified by a support frame 200. While web frame 100 has been shown as an interconnection of thin straps that may be sewed, stapled, or otherwise interwoven, other varieties of webbed frame components may exist such as rope components (e.g., a rope portion 10) that are either knotted together where junction points P and X may be located. Alternatively, there may be an additional frame assembly (not shown) that goes over frame assembly 200 to provide even further rigidity to the debris collection and disposal system. The frame 200 and webbed frame 100 may be strong and rigid enough to handle the forces exerted thereon during the particular uses to which the corresponding debris collection and disposal system may be made. All of the aforementioned designs and alternatives apply equally to the netting 90, 91, 92, 93, and 94. Further, while netting 90, 91, 92, 93, 94 may take the form of linked or meshed fabric, some, all, or a pattern/combination of each may be of any material with sufficient structure to contain debris, e.g., tarp material. For example, the netting 90, 91, 92, 93, 94 may be a large cell net-like pattern for collecting large leaves and bags while another type of netting may be like a plastic bag (e.g., a waste disposal plastic bag) that has no orifices for small debris passage, e.g., plastic tarp or burlap. In another exemplary embodiment, netting 90 may be a tarp or rubber material to allow for easy transportation across surfaces, e.g., grass, gravel, concrete, sand. In combination, the debris collection and disposal system may be described as a canopy into which waste is sent and which is rigidified by frame 200. The canopy may have an opening at the front (e.g., the portions of the webbed netting system 100 that comprise points P and Q), a closure in the back (e.g., the portions of the webbed netting system 100 that comprise points P and X and/or the junction of webbed netting system 100 that forms loop 19), and an over structure (e.g., the portions of the webbed netting system that extend upwardly to points Q along spine 17) that is above a base (e.g., the portions of the webbed netting system that connect points P and X).

With reference to FIGS. 4A and 4B, an exemplary sleeve 21/26 may have openings 45 for receipt of pipes 32/33/34. Slot 40 may be formed through the thickness of such a sleeve 21/26 to allow for receipt of a portion of web strap system 100 (e.g., straps 10 and/or netting 90/91/92/93/94) via conduit 40A. Conduit 40A may be smooth or contoured to facilitate ready holding of web strap system 100. Alternatively, conduit 40A may have clamping or snap-fit features to hold complementary surfaces on web strap system 100 portions in place. Thus, while the portion of web strap system 100 may be held within opening 45, the contour and structures on conduit 40A may aid in keeping web strap system 100 from disengaging during debris collection and removal via system 200. Alternatively, a smooth conduit 40A may be all that is necessary based on the angle formed with slot 40. For example, a smooth conduit 40A at a 90 degree or less angle with slot 40 may create a difficult path by which any web system 100 portion may need to travel to break free of sleeve 21/26. In this way, the angular orientation of smooth conduit 40A and slot 40 may be all that is required to keep web system 100 from getting free of the support frame 200. In another embodiment, the interaction between frame 200 components in opening 45 and the retained portion of web system 100 may enable the adjoining frame component 200 to further hold the retained portion of web system 100 from moving or departing from frame 200.

In an alternative embodiment, illustratively shown by FIG. 4B, an exemplary sleeve 21/26 may have openings 45 for receipt of additional sleeves 21 or other components of frame 200. In contrast to the illustrative embodiment of FIG. 4A, the instant sleeve 21/26 may have a slot 40 adjacent an adaptor 21A, which contains one or more surfaces for retaining netting 90/91/92/93/94 and/or any other components of web system 100 and/or frame 200. For example, adaptor 21A may have a hook 41 used to retain webbed system 100 and/or netting 90/91/92/93/94. A clamp 42 on adaptor 21A may be used to hold another component of frame 200 or web system 100. An exemplary clamp 42 may be static or dynamic, e.g., movable using springs, ratcheting mechanisms, or mechanical compression techniques known to those skilled in the art. Adaptor 21A may have jaw 43 and throat 44 for an additional retention location of webbed system 100 and/or netting 90/91/92/93/94. Like slot 40 and conduit 40A, jaw 43 and throat 44, respectively, may be similarly configured for retaining other system 100 portions or netting 90/91/92/93/94. In another exemplary embodiment, adaptor 21A may be used by external devices to maneuver, hold, store, or otherwise manipulate the fully-assembled frame 200 of the debris collection and disposal system.

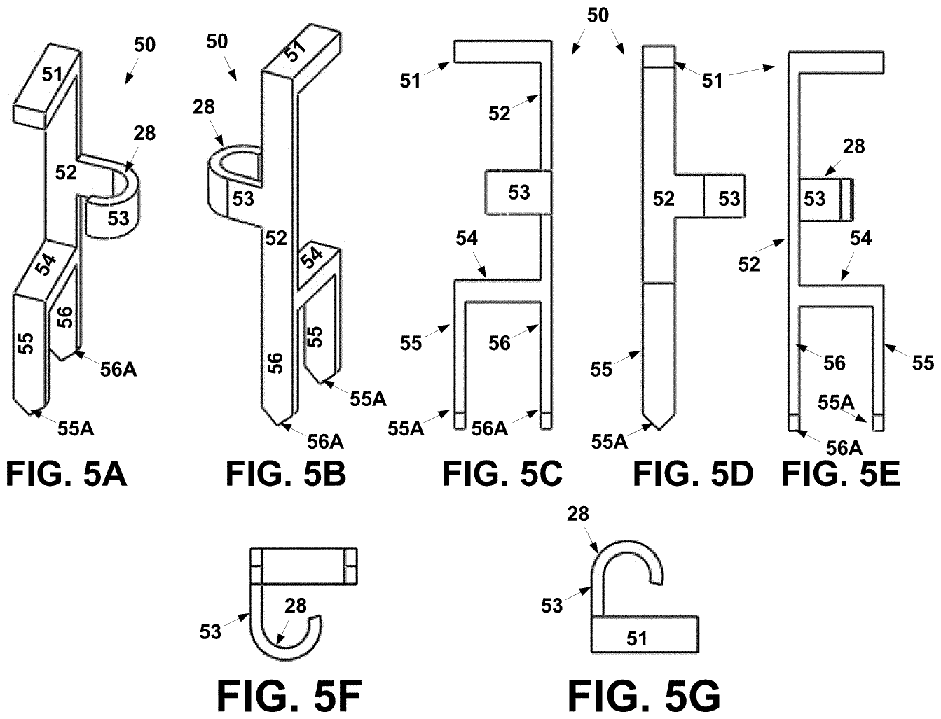

As illustratively provided for in FIGS. 5A-G, exemplary stake 50 may hold the debris collection and disposal system to the ground and/or supplement vertical rigidity and structural support to the pipes 32 via installation through grommets 25. In one embodiment, stake 50 uses a “J” clip 53 that loops around pipe 32 most proximal to grommet 25 in the holding surface 28. In this way, an exemplary stake 50 may be quickly and easily attached to support frame 200. A head 51 may be oriented above the J clip 53 to allow the entirety of stake 50 to be inserted into the ground for anchoring of the debris collection and disposal system, i.e., by impacting head 51 with a user foot, hammer, or other tool. As described, an exemplary stake 50 may enable the support frame 200 to easily fill the netting 91/92/93/94 with debris while restricting movement of frame 200. An exemplary stake 50 comprises a body 52 interconnecting J clip 53 to head 51. A seat 54 may extend from body 52 to adjoin a first leg 55, which is substantially parallel with a second leg 56 that may be integral with body 52. Each of the first leg 55 and second leg 56 may have corresponding feet 55A and 56A, respectively. The size and dimension of each of the first leg 55, second leg 56, foot 55A, and foot 56A may be such as to accommodate the intended use of the support frame 200 of debris collection and disposal system. In one embodiment, 55A and 56A may be sharp to allow penetration into dirt, gravel, or rock. In another embodiment, 55A and 56A may be arrow-shaped or tubular to allow for penetration and retention into sand. In yet another embodiment, 55A and 56A may be shaped to fit inside and lock within a corresponding hole or lock in concrete or other man-made surface to allow for the support frame 200 to be anchored down during use. While stake 50 may be integral throughout its structure, an exemplary stake 50 may also be capable of disassembly to allow a user to switch between legs 55/56 and/or feet 55A/56A. Additionally, there may be more than one J-clip 53 along the length of body 52 to accommodate different types of pipes 32.

By using a combination of tarp-like material (e.g., 90) and breathable netting (e.g., 91-94), an exemplary debris collection and disposal system may make for a single integrated unit to easily add or remove material to/from the waste transport system while using a cleaning device, e.g., rakes, skimmers, leaf/snow blowers, by allowing air to freely travel through the exterior netting 91-94. The handles 24 of an exemplary debris collection and disposal system can also facilitate moving and dumping of contents. Where a tarp or other appropriately rigid material is used for netting 90, the system may be transported along a surface to a desired location (e.g., gliding across grass, stones, concrete, sand, rocks).

In another exemplary embodiment, the pipes 32, 33, and 34 and sleeves 21/26 of the frame 200 may be disconnected but still fitted about webbed system 100 so that the partially-disassembled frame 200 may be malleable for purposes of packaging the entire debris collection and disposal system in a smaller space than would be possible if left fully assembled. In other words, webbed system 100 straps may still hold all the pipes 32-34 and sleeves 21/26 to which they were connected even though the pipes 32-34 and sleeves 21/26 are themselves not fitted together. This feature may allow users to easily roll up the debris collection and disposal system when not in use and store the same in an appropriate location.

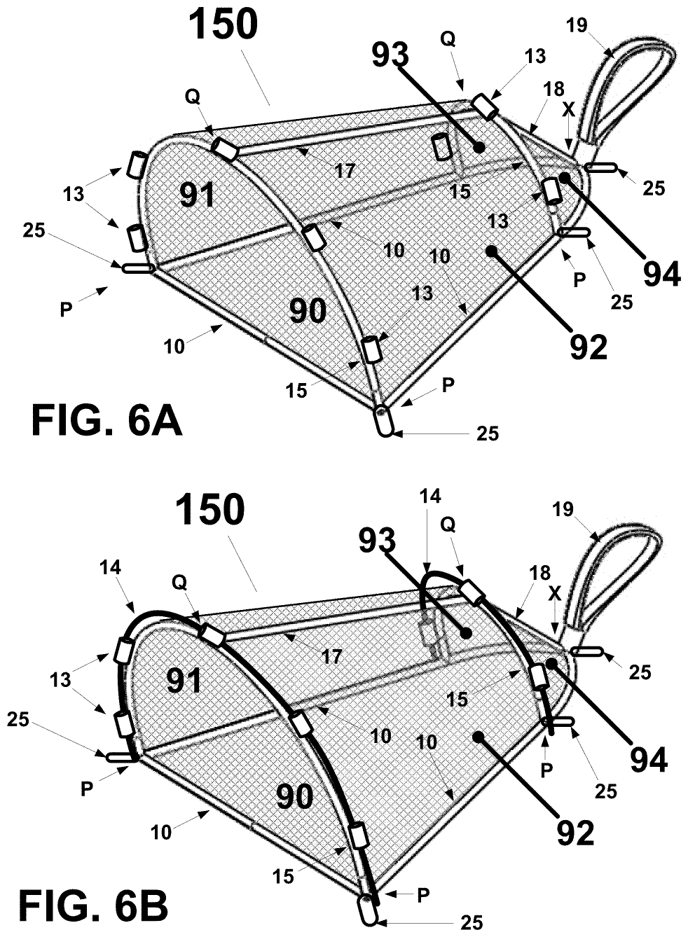

With reference to FIG. 6A, an exemplary webbed system 150 may be substantially similar to webbed system 100 with the exception that in addition to loop straps 15 there are one or more insert straps 13 displaced along and/or about the length of loop strap 15, e.g., at point Q. In one embodiment, the insert straps 13 extend perpendicularly from loop strap 15. In another embodiment, insert straps 13 are threaded in series with the remainder of loop strap 15. A further contrast between the exemplary webbed system 150 and an exemplary webbed system 100 may be illustratively shown in grommets 25, which appear as metal hoops or reinforced strapping located at points P and X. Insert straps 13 may be sized, configured, and formed so as to hold and retain a resilient metal wire post 14 that is bent to pass through the insert straps 13—as may be illustratively shown in FIG. 6B. According to this exemplary embodiment illustratively disclosed in FIG. 6B, post 14 may pass through one or more grommets 15 located at points P in webbed system 150. Alternatively, the ends of post 14 may be inserted into fittings to which mobile systems may be provided (not shown), such as wheels, skis, tracks, or hooks.

An exemplary webbed system 150 may function and be tethered to surfaces using one or more stakes 50 as illustrated in FIGS. 5A-G, Similar to how hook 53 and surface 28 may be used to hold pipes 32/33 to stake 50, hook 53 and surface 28 may be configured and/or dimensioned so as to retain post 14. While post 14 may be illustrated as a uniform pipe or pole (e.g., one made of flexible but resilient metal), post 14 may be constructed in pieces and parts that allow for assembly, telescopic extension capability, to be magnetized, and to have piercing ends to engage a particular surface (e.g., soil or sand). Moreover, the ends of post 14 may be weighted to hold the post 14 in a particular bent configuration and resist returning to a prior, un-bent condition thereby undermining the maintenance of opening in webbed system 150.

While the reinforced systems illustrated in FIGS. 1B and 6B are shown with distinct components, those skilled in the art would appreciate the synergies of combining the two systems into one. For example, post 14 while threaded through inserts 13 may be inserted through the slot 40A of pipes 21 to have a reinforced webbed system component encompassed within an exoskeletal pipe/covering component.

With reference to any of the foregoing embodiments, the lowermost strap 10 or pipe 11 coupled to the same may be slanted or contoured facing away from the internal canopy formed by the netting 90-94 to facilitate receipt of debris therein by blowing, raking, sweeping, etc. so that no debris is caught between the surface of the lower strap 10 and/or pipe 11. Alternatively a ramp attachment (not shown) may be clipped, mechanically fastened, or welded to the lower strap 10 and/or its coupling pipe 11 to enable the aforementioned debris collection efficiencies. The lowermost strap 10 or pipe 11 may also be weighted to maintain contact with the support surface on which the debris system is placed.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A debris removal system, comprising:
a plurality of straps and netting interconnected to one another;
a reinforcement coupled to a portion of the plurality of straps that raises at least a portion of the netting upward from a support surface to form a netted canopy; and
at least one grommet coupled to the debris removal system for securing the same to the support surface.

2. The system of claim 1, wherein the reinforcement is selected from the group consisting of sleeves, pipes, posts, and a combination of the foregoing.

3. The system of claim 2, wherein the reinforcement is a post.

4. The system of claim 3, wherein the coupling between the post and the portion of the plurality of straps is via at least one insert.

5. The system of claim 1, wherein the plurality of straps and netting terminate in a tow loop.

6. The system of claim 2, wherein the reinforcement forms a loop with the portion of the plurality of straps.

7. The system of claim 6, wherein the reinforcement is a post.

8. The system of claim 7, wherein the coupling between the post and the portion of the plurality of straps is via at least one insert.

9. The system of claim 2, wherein the reinforcement is a plurality of pipes.

10. The system of claim 9, wherein the coupling between the plurality of pipes and the portion of the plurality of straps is via at least one sleeve.

11. The system of claim 10, wherein the plurality of pipes and at least one sleeve form at least one loop with the portion of the plurality of straps.

12. The system of claim 11, wherein a portion of the plurality of pipes are a combination of arched and straight pipes.

13. A debris removal system, comprising:
at least one webbed system;
at least one reinforcement for converting the at least one webbed system into a canopy; and
at least one interconnection between the at least one reinforcement and the at least one webbed system, wherein the at least a one interconnection releasably couples the at least one reinforcement to the at least one webbed system.

14. The system of claim 13, wherein the at least one reinforcement is selected from the group consisting of sleeves, pipes, posts, and a combination of the foregoing.

15. The system of claim 14, wherein the at least one reinforcement is a post.

16. The system of claim 15, wherein the at least one interconnection is an insert coupled to the at least one webbed system.

17. The system of claim 13, further comprising a plurality of grommets coupled to the at least one webbed system.

18. The system of claim 17, wherein the at least one reinforcement intersects with the plurality of grommets.

19. The system of claim 16, further comprising a plurality of grommets coupled to the at least one webbed system.

20. The system of claim 19, wherein the post intersects with the plurality of grommets.
